(19) United States
(12) Patent Application Publication
(10) Pub. No.: US 2006/0213477 A1
(43) Pub. Date: Sep. 28, 2006

(54) Pump combination

(75) Inventors: Heiko Schulz-Andres, Hueckeswagen (DE); Christoph Duerr, Solingen (DE); Dirk Kamarys, Heme (DE); Petra Karger, Heme (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Luk Automobiltechnik GMBH & Co. KG, Hueckeswagen (DE)

(21) Appl. No.: 10/545,460

(22) PCT Filed: Feb. 12, 2004
(86) PCT No.: PCT/DE04/00250

§ 371 Date: May 2, 2006

(30) Foreign Application Priority Data
Feb. 14, 2003 (DE) 103 06 164.9

(51) Int. Cl. F01M 1/02; F16N 13/20

(52) U.S. Cl. 123/196 R; 184/31

(57) ABSTRACT

The invention relates to a pump combination comprising a first pump and at least one second pump.

The present invention is directed to a pump combination including a first pump and at least one second pump, the first pump being used for delivering lubricating oil for a combustion engine. Such pump combinations are generally known. Thus, today's motor vehicles have, in series, a pressure pump, as an external-gear pump, for delivering the lubricating oil of the combustion engine, in conjunction with three further suction pumps. These suction pumps are likewise designed as gear pumps. The inherent disadvantage of this concept is that the individual pump stages are installed axially one behind the other, so that a pressure-tight separation is still required between each pump stage. As a result, this system, when assembled, has very large axial dimensions. Moreover, problems arise in the supplying of oil-air mixtures.

It is, therefore, the object of the present invention to devise a pump combination which will overcome these disadvantages.

This objective is achieved by a pump combination which includes a first pump and at least one second pump, it being possible for the first pump to be a vane pump for delivering lubricating oil of a combustion engine, thus functioning as a pressure stage, and the first pump additionally supplying oil to at least the second pump.

In accordance with the present invention, the second pump may be constituted of a single-vane pump, for example of the vacuum type of pump design, whose lubricating-oil supply for lubricating a coupling and the rotary assembly, and for sealing the sealing gap is provided by the first pump. A single-vane pump has the advantage of a very positive ratio of required space to useful space. Since, in accordance with this pump principle, an adequate delivery is provided even at very low speeds, a reduction in the pump size is possible in comparison to conventional gear pumps, for a “suction” application. As a result, the frictional loss and the air-oil flow rate in the oil-pan space are able to be reduced. This type of pump of construction is also especially well suited for delivering an air-oil mixture, or for delivering only air.

In addition, a pump combination is preferred, in which the second pump is a two-stroke vane pump whose undervane pressure supply is provided by the first pump. A pump combination is preferred as well, in which the undervane pressure supply of the second pump is provided by the undervane pressure supply of the first pump. This is possible, in particular, when the delivery rate of the first pump is substantially greater than that of the second pump. It is, thus, easily possible to couple the undervane pressure supply of the smaller second pump to the undervane supply of the larger first pump in the inner region of the vane pump, without entailing substantial outlay for manufacturing.

A pump combination is also preferred, whose first pump is a two-stroke vane pump, whose second pump is a two-stroke vane pump, and whose third pump is a single-vane pump, and in which the first pump supplies the second and third pumps with oil. Since the first pump constitutes a so-called pressure stage and may deliver pressurized oil, it may also assume the task of supplying the undervane pressure or the lubricating oil for the two other pumps, which function as suction stages, for example, and thus are not able to build up any positive pressure and, consequently, not enough pressure for supplying their own oil pressure.

A pump combination in accordance with the present invention has the distinguishing feature that the second two-stroke vane pump is used as a suction pump, for example for the lubricating oil of turbochargers, superchargers, or compressors. A pump combination is preferred in which the two kidney-shaped suction ports of the second vane pump communicate with two independent, mutually separate suction regions, and each suction region suctions the lubricating oil of a turbocharger, supercharger, or compressor. The two separate kidney-shaped suction ports featured in the two-stroke vane pump design have the significant advantage of enabling virtually two pumps to be provided in one small axial space. Moreover, the pumps do not entail any axial intermediate walls, as normally required for two gear-pump suction stages. Apart from the advantage of small axial depth of the installation space, the advantage of fewer parts, reduced expenditure for assembly, and reduced costs should be pointed out.

A pump combination is also preferred, in which the two kidney-shaped pressure ports of the second vane pump deliver to a common pressure region, which communicates with the oil pan of the combustion engine.

A pump combination is also preferred, in which the housing of the second vane pump may be made of plastic. This is possible because this second vane pump functioning as a suction stage only experiences a slight negative pressure and is also not subjected to any positive pressure, since it delivers back into the oil pan, virtually unpressurized. In addition, a pump combination is preferred, whose second vane pump, instead of an undervane pressure supply, may feature a forced guidance underneath the vanes as the result of a contour ring. Here, the advantage is derived that the contour ring extends the vanes in the suction region already at low speeds, allowing the oil to be suctioned immediately at start-up. At higher speeds, the centrifugal forces then assume the task of extending the vanes in the suction region.

A pump combination is also preferred, whose single-vane pump is used as a suction pump/scavenge pump for a portion of the oil pan that, due to the motor vehicle design, is located at a distance from the area of the oil pan from where the main oil delivery pump draws the oil. The suction pump suctions existing oil or an oil-air mixture or, when an oil-air mixture is no longer present, air, from there (out of the oil sump) and returns it to the main oil sump of the oil pan of the combustion engine, in the area of the oil pickup location of the first pump. The need may arise, particularly when a motor vehicle is in an inclined position, off-highway, for oil to be scavenged from remote areas of the oil pan and fed to the pickup location of the main oil pump.

A pump combination is also preferred, in which the single-vane pump has widened opening cross-sections (as compared to a conventional vacuum pump) without any non-return valves. This makes it possible for a single-vane pump of this kind to be advantageously operated without any high pressure peaks, even when the suction operation is carried out at maximum oil fill capacity, thereby making it possible to avoid damage to the pump.

A pump combination is also preferred, in which the housing of the single-vane pump is made of plastic. This is possible because the pump functioning as a suction stage is subjected to little negative pressure and experiences low pressure peaks on the pressure delivery side. As a result, housings having relatively large tolerances are also possible, which do not require any secondary machining.

A pump combination is also preferred, in which the single-vane pump has lubrication pockets in the rotor bearing for periodically lubricating the sealing gap.

A pump combination according to the present invention is distinguished in that all three pumps are driven by a common shaft.

A pump combination is also preferred, in which the first pump, thus the vane pump for the pressure stage, is a two-stroke vane pump and has a pressure regulating valve and a temperature control valve, which, in response to a temperature increase, brings a second flow of the vane pump from the unpressurized circulation to the pressure circuit. A pump combination is also preferred, in which the first pump features a controllable stroke volume adjustment.

The present invention is described with reference to the figures, which show:

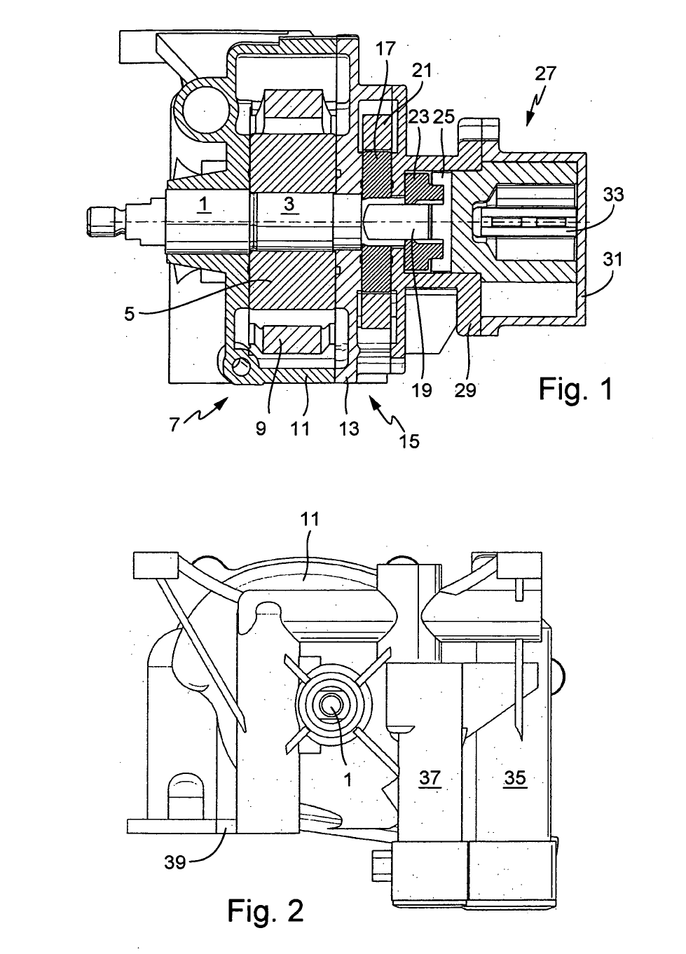

FIG. 1 a pump combination according to the present invention, in cross section.

FIG. 2 an exterior view of the pump combination, looking at the drive shaft.

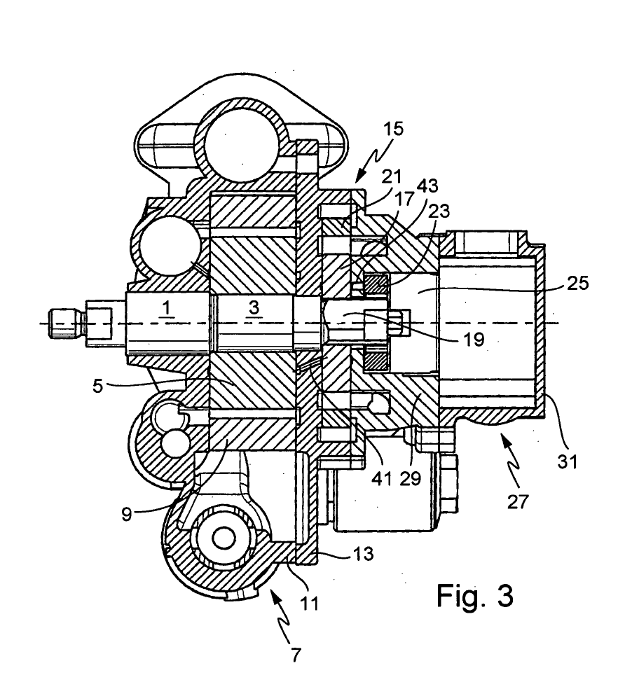

FIG. 3 another cross section through the pump combination.

FIG. 1 shows a cross section through the pump combination having three pumps. Rotor 5 of first vane pump 7 is mounted on a drive shaft 1 in shaft region 3. Also discernible is a section through lifting ring 9. Vane pump 7 is accommodated in a housing 11, which is sealed by an end cover 13. End cover 13 additionally functions as a holding housing for second vane pump 15, which is built to be substantially smaller and narrower than first vane pump 7. Rotor 17 of second vane pump 15 is mounted on shaft region 19 of shaft 1 and is likewise driven by shaft 1. A section through lifting ring 21 of second vane pump 15 is likewise discernible. In addition, a coupling part 23, which engages with a rotor 25 of single-vane pump 27, is also discernible on shaft section 19 of shaft 1. Single-vane pump 27 is flange-mounted by a housing flange 29 on second vane pump 15 and is sealed at the outward end by a housing part 31. Single vane 33 is discernible in cross section within rotor 25.

The first pump, vane pump 7, constitutes the main oil delivery pump for a combustion engine of a motor vehicle. It draws lubricating oil from the oil sump and delivers it as pressurized oil to the lubrication points of the combustion engine. The second, substantially smaller vane pump 15 is used as a suction pump for turbochargers, superchargers or compressors present in the motor vehicle and suctions the lubricating oil from there, and returns it to the oil pan of the combustion engine. The third pump, single-vane pump 27, is used as a suction pump for remotely disposed regions of the oil pan, from where, under certain conditions, such as inclination of the motor vehicle, off-highway, the oil is no longer able to arrive by its own oil return flow to the pickup location for main oil delivery pump 7. The design of single-vane pump 27 makes it particularly suited for delivering oil-air mixtures, as well as only air, which it delivers as soon as the process of scavenging the remote oil pan regions is completed. Second vane pump 15, not visible in the illustration here, is designed as a two-stroke vane pump and thus virtually constitutes two pumps in one component. Two-stroke vane pumps, as such, are generally known and are, therefore, not described in greater detail here. In principle, this type of construction makes it possible for a dual pump to be mounted in this axially very narrow area, so that its first flow is able to discharge the lubricating oil from a first turbocharger, and its second flow is able to discharge the lubricating oil from a second turbocharger. To that end, as already mentioned at the outset, the first suction region of vane pump 15 communicates with the first turbocharger, and the second suction region communicates with the second turbocharger. The oil flows of the two suction regions are then returned via the kidney-shaped pressure ports of vane pump 15 to a common pressure region and, subsequently, into the oil pan, the pressure region, itself, remaining unpressurized, in principle, since no particular pressure-increasing resistances oppose this oil flow. Thus, in accordance with the present invention, this pump combination ideally contains pump types specially selected for the appropriate areas of activity, and is additionally distinguished by a small axial space, which is especially beneficial for installation situations relating to an engine oil pan of a motor vehicle.

FIG. 2 shows a plan view of pump housing 1, looking at shaft 1 projecting out from the housing. In addition, housing 11 has installation spaces 35 and 37 for a pressure regulating valve and a temperature control valve. In this context, in the case of the likewise two-stroke main pump 7, at low oil temperatures, the temperature control valve has the function of bringing one of the two flows into unpressurized circulation and, at high oil temperatures, when the combustion engine has high consumption demands for lubricating oil, to couple the second flow to the first flow, i.e., to the pressure region. The pressure regulating valve regulates the maximum permissible oil pressure in the lubricating oil system. In addition, housing 11 has flange-mounting surfaces 39, which provide for the transition to the oil pan or to other engine areas and to the lubricating oil system and, in this context, also feature the corresponding leadthroughs for the oil channels.

FIG. 3 shows another section through the pump combination according to the present invention. Components equivalent to those in FIG. 1 are denoted by the same reference numerals and will not be described again, for the sake of avoiding repetition. Also discernible in FIG. 3 is, however, the oil feed to second pump 15 and to third pump 27 provided by first pump 7. Visible in housing part 13, which seals housing 11 of pump 7 and, at the same time, constitutes the housing for second pump 15, is an oil channel 41, which leads from the undervane oil supply of pump 7 to the undervane oil supply of pump 15. The function of supplying hydraulic pressure underneath the vanes is likewise generally known and, therefore, will also not be described in greater detail here. The undervane pump of pump 7 is generally supplied with pressurized oil of pump 7 and thus also delivers pressurized oil via line 41 to pump 15, which is used as a suction pump for the turbocharger and, therefore, is not able to build up any appreciable oil pressure. For that reason, this pump would also not be able to reliably press the vanes out of the slots using its own oil pressure. The supplying of oil continues via the undervane pump of second pump 15 by way of an oil supply channel 43, to coupling 23 of single-vane pump 27. As a result, both coupling 23, which engages with rotor 25, is supplied with the requisite lubricating oil, as are the rotor bearing of rotor 25 and the contact faces of the single vane (not shown here) within rotor 25. In addition, the lubricating oil is used for sealing the gap, in cases of air delivery only.

1-17. (canceled)

18. A pump combination comprising:
a first pump configured to supply lubricating oil of a combustion engine; and
at least one second pump, wherein the first pump additionally provides for the lubricating oil to be supplied to the at least one second pump.

19. The pump combination as recited in claim 18, wherein the first pump is a vane pump.

20. The pump combination as recited in claim 18, further comprising a rotor assembly, a coupling, and a sealing gap, wherein the second pump is a single-vane pump, and wherein the first pump provides the lubricating oil for lubricating the coupling and the rotary assembly, and for sealing the sealing gap.

21. The pump combination as recited in claim 20, wherein the second pump is a vacuum type pump.

22. The pump combination as recited in claim 18, wherein the second pump is a two-stroke vane pump, an undervane pressure supply of the second pump being provided by the first pump.

23. The pump combination as recited in claim 22, wherein the undervane pressure supply of the second pump is provided by an undervane pressure supply of the first pump.

24. The pump combination as recited in claim 18, further comprising a third pump, and wherein the first pump supplies the lubricating oil to the third pump.

25. The pump combination as recited in claim 24, wherein the first pump is a two-stroke vane pump, the second pump is a two-stroke vane pump, and the third pump is a single-vane pump.

26. The pump combination as recited in claim 22, wherein the second two-stroke vane pump is a suction pump.

27. The pump combination as recited in claim 26, wherein the suction pump is configured for the lubricating oil of at least one of a turbocharger, a supercharger, and a compressor.

28. The pump combination as recited in claim 27, wherein the second vane pump includes two kidney-shaped pressure ports communicating with two independent, mutually separate suction regions, and each suction region suctions the lubricating oil of the at least one of the turbocharger, the supercharger, and the compressor.

29. The pump combination as recited in claim 28, wherein the two kidney-shaped pressure ports of the second vane pump deliver into a common pressure region communicating with the oil pan of the combustion engine.

30. The pump combination as recited in claim 22, wherein the second pump includes a housing that includes a plastic.

31. The pump combination as recited in claim 18, wherein the second pump is a vane pump including a plurality of vanes and a contour ring for providing a forced guidance underneath the vanes.

32. The pump combination as recited in claim 20, wherein the single-vane pump functions as at least one of a suction pump and a scavenge pump for a portion of an oil pan of the combustion engine suctioning at least one of oil existing in the portion of the oil pan, an oil-air mixture and, when oil is not present, air, and returning it to a main oil sump of the oil pan in an oil pickup location of the first pump.

33. The pump combination as recited in claim 22, wherein the single-vane pump has opening cross-sections wider than a conventional vacuum pump for a combustion engine and does not include any non-return valves.

34. The pump combination as recited in claim 22, wherein the single-vane pump includes a housing including a plastic.

35. The pump combination as recited in claim 20, wherein the single-vane pump has a rotor bearing and lubrication pockets in the rotor bearing for periodically lubricating the sealing gap.

36. The pump combination as recited in claim 24, further comprising a common shaft driving the first, second, and third pumps.

37. The pump combination as recited in claim 18, wherein the first pump is a two-stroke vane pump and has a pressure regulating valve and a temperature control valve, and wherein, in response to a temperature increase, the first pump brings a second flow from an unpressurized circulation into a pressure circuit.

38. The pump combination as recited in claim 18, wherein the first pump features a controllable stroke volume adjustment.
